(19) United States
(12) Patent Application Publication
(10) Pub. No.: US 2026/0364729 A1
(43) Pub. Date: Nov. 19, 2026

(54) MACHINING SYSTEM AND MACHINING METHOD

(71) Applicant: Mitsubishi Electric Corporation, Tokyo (JP)

(72) Inventor: Hideaki IKEMOTO, Tokyo (JP)

(73) Assignee: Mitsubishi Electric Corporation, Tokyo (JP)

(21) Appl. No.: 19/142,969

(22) PCT Filed: Jun. 22, 2023
(86) PCT No.: PCT/JP2023/023187

§ 371 Date: Jun. 25, 2025

(51) Int. Cl. B23Q 41/06; G05B 19/418

(52) U.S. Cl. CPC B23Q 41/06; G05B 19/4185

(57) ABSTRACT

A machining system includes a machine tool connected to a network, machine tools connected to the network, and a hand-held terminal for operating the machine tools, where the hand-held terminal is connected to the machine tool via a connection line. The hand-held terminal sends first operation information for operating the machine tool or second operation information for operating the machine tools to the machine tool. The machine tool performs processing corresponding to the first operation information when the machine tool receives the first operation information from the hand-held terminal, and relays the second operation information to the machine tools via the network when the machine tool receives the second operation information from the hand-held terminal. The machine tools perform processing corresponding to the second operation information when the machine tools receive the second operation information.

### FIELD

The present disclosure relates to a machining system in which machine tools are operated using an operational terminal, and to a machining method and a processing program.

### BACKGROUND

An operational terminal such as a hand-held terminal is a device capable of communicating with a machine tool connected thereto via a communication line, and of manually operating the machine tool. The hand-held terminal includes an operation unit, such as an operation switch, for operating the machine tool. Operating the operation unit enables a user to operate the machine tool at a location distant from an operation screen provided on the machine tool.

When operating the machine tool using a hand-held terminal, the user usually connects the hand-held terminal directly to the machine tool to be operated, to thus operate the machine tool, for example, while checking the status of ongoing machining of the work in that machine tool. In this process, use of multiple machine tools requires multiple hand-held terminals corresponding to the multiple respective machine tools.

The hand-held terminal described in Patent Literature 1 is connected to a transmission station to which the target device is connected during work to operate devices of a plant facility. This hand-held terminal described in Patent Literature 1 identifies an identification symbol of the transmission station connected thereto, and automatically generates an operation screen corresponding to the device connected to this transmission station identified. This enables multiple devices to be operated using a single hand-held terminal.

### CITATION LIST

### Patent Literature

Patent Literature 1: Japanese Patent Application Laid-open No. H10-011690

### SUMMARY OF INVENTION

### Problem to be Solved by the Invention

However, the technology of Patent Literature 1 described above has a problem of the need to establish another connection between a device and the hand-held terminal via a transmission station when the devices to be operated are changed from one to another.

The present disclosure has been made in view of the foregoing, and it is an object of the present disclosure to provide a machining system capable of operating multiple machine tools using a single operational terminal without establishing another connection between a machine tool and the operational terminal.

### Means to Solve the Problem

To solve the problem and achieve the object described above, a machining system of the present disclosure includes a first machine tool connected to a network, a second machine tool connected to the network, and an operational terminal for operating the first machine tool and the second machine tool, where the operational terminal is connected to the first machine tool via a connection line. The operational terminal sends, to the first machine tool, first operation information for operating the first machine tool or second operation information for operating the second machine tool. The first machine tool performs processing corresponding to the first operation information when the first machine tool receives the first operation information from the operational terminal, and relays the second operation information to the second machine tool via the network when the first machine tool receives the second operation information from the operational terminal. The second machine tool performs processing corresponding to the second operation information when the second machine tool receives the second operation information.

### Effects of the Invention

A machining system according to the present disclosure provides an advantage in capability of operating multiple machine tools using a single operational terminal without establishing another connection between a machine tool and the operational terminal.

### BRIEF DESCRIPTION OF DRAWINGS

FIG. 1 is a diagram illustrating an exemplary configuration of a machining system according to an embodiment.

FIG. 2 is a diagram illustrating an exemplary appearance configuration of a hand-held terminal included in the machining system according to the embodiment.

FIG. 3 is a flowchart illustrating a processing procedure followed by the machining system when the hand-held terminal sends operation information to a machine tool in the machining system according to the embodiment.

FIG. 4 is a flowchart illustrating a processing procedure followed by the machining system when another machine tool sends display information corresponding to operation information to the hand-held terminal in the machining system according to the embodiment.

FIG. 5 is a diagram illustrating an exemplary hardware configuration for implementing the machine tools according to the embodiment.

### DESCRIPTION OF EMBODIMENT

A machining system, a machining method, and a processing program according to an embodiment of the present disclosure will be described in detail below with reference to the drawings.

### Embodiment

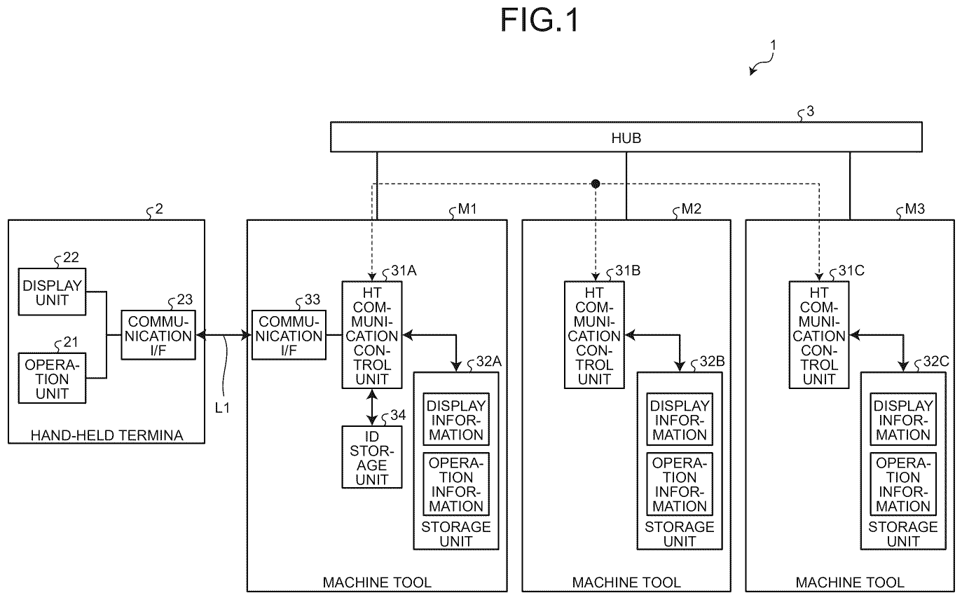

FIG. 1 is a diagram illustrating an exemplary configuration of a machining system according to an embodiment. A machining system 1 includes a single hand-held terminal 2, machine tools M1 to M3, and a hub 3.

The hand-held terminal 2 is an operational terminal for operating the machine tools M1 to M3. Note that although the first embodiment will be described in which the machining system 1 includes the three machine tools M1 to M3, what is characteristic of the machining system 1 is inclusion of multiple (i.e., two or more) machine tools. The machining system 1 may thus include two, or four or more, machine tools.

One machine tool among the machine tools M1 to M3 included in the machining system 1 is a primary machine tool that directly communicates with the hand-held terminal 2. The embodiment is described below with respect to a case where the machine tool M1 is the primary machine tool. Note that the machine tool M1 that is the primary machine tool may hereinafter be referred to as representative machine tool M1. In addition, the machine tools M2 and M3, which are the machine tools other than the machine tool M1, may hereinafter be referred to as remaining machine tools M2 and M3.

The representative machine tool M1 is a first machine tool, and the remaining machine tools M2 and M3 are each a second machine tool. In a case where the machining system 1 includes two machine tools, the remaining machine tool is one machine tool that is either the machine tool M2 or the machine tool M3. Note that when there is no need to distinguish the machine tools M1 to M3, the machine tools M1 to M3 may each be referred to as machine tool Mx.

The machine tools M1 to M3 are connected to the hub 3 to enable communication with each other. The hand-held terminal 2 is connected to the representative machine tool M1 to enable communication with each other. The representative machine tool M1 relays information to enable the hand-held terminal 2 of the embodiment to communicate with the remaining machine tools M2 and M3. The hand-held terminal 2 performs, on the machine tools M1 to M3, what has been instructed by a user according to an instruction from the user. In addition, the hand-held terminal 2 obtains information from the machine tools M1 to M3 according to an instruction from the user.

The machine tools M1 to M3 send and receive information to and from the machine tools Mx through a network connection. Note that the machine tools Mx may communicate with each other using a communication standard specific to the machine tools Mx or a general-purpose communication standard.

Note that in the machining system 1, the representative machine tool M1 may communicate with the remaining machine tools M2 and M3 through a network connection via the hub 3 or through a network connection that directly connects the representative machine tool M1 and the remaining machine tools M2 and M3. In FIG. 1, replacement of the hub 3 with a connection line enables a network to be provided that directly connects the representative machine tool M1 and the remaining machine tools M2 and M3.

The machine tools M1 to M3 are connected with, for example, a control device, a sensor, a drive device, and/or the like, and send and receive information using an industrial network (field network) used for performing device control, device state monitoring, and the like.

Examples of this industrial network include Control and Communication (CC)-Link, Profibus (Process Field Bus), Ethernet (registered trademark)/Internet Protocol (IP), and FL-net. The machine tools M1 to M3 perform data communication dependent on the communication scheme of the industrial network.

The machine tools M1 to M3 each store device identification information (ID) of that machine tool for identification of that machine tool. The representative machine tool M1 includes an ID table that associates IDs of the machine tools M1 to M3 with communication addresses of the respective machine tools M1 to M3. The representative machine tool M1 relays information between the hand-held terminal 2 and the machine tools M2 and M3 using the ID table.

The hand-held terminal 2 includes an operation unit 21, a display unit 22, and a communication interface (I/F) 23. The representative machine tool M1 includes an HT communication control unit 31A, a storage unit 32A, a communication I/F 33, and an ID storage unit 34. In addition, the remaining machine tool M2 includes an HT communication control unit 31B and a storage unit 32B. Moreover, the remaining machine tool M3 includes an HT communication control unit 31C and a storage unit 32C.

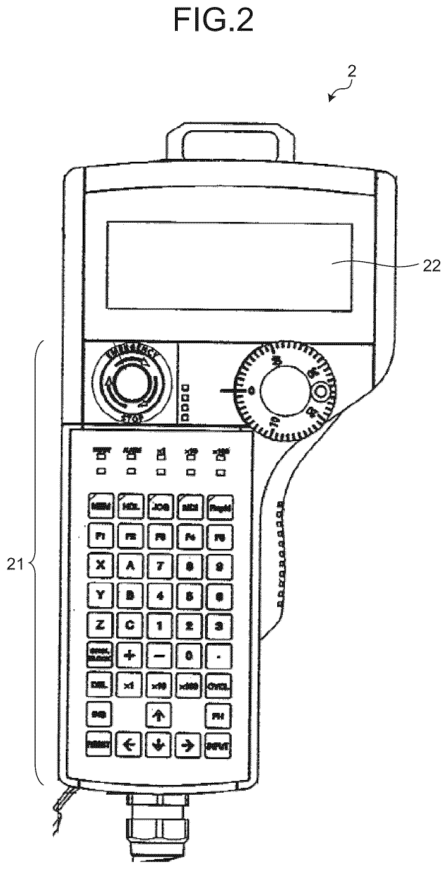

An appearance configuration of the hand-held terminal 2 will next be described. FIG. 2 is a diagram illustrating an exemplary appearance configuration of the hand-held terminal included in the machining system according to the embodiment. The hand-held terminal 2 includes the operation unit 21 and the display unit 22. The operation unit 21 is a set of an operation switch, operation buttons, a control dial, and/or the like, and receives an instruction corresponding to a user operation. The user operation is an operation for operating the machine tools Mx. That is, the operation unit 21 receives, from the user, an instruction for causing one of the machine tools Mx (hereinafter referred to simply as a machine tool Mx) to perform specific processing.

An example of the display unit 22 is a liquid crystal display to display various types of information. The display unit 22 displays, for example, the name of the machine tool Mx to be operated (i.e., tool name), candidate operation details directed to a machine tool Mx, operation information representing operation details specified by the user, information regarding a machine tool Mx received by the communication I/F 23 from the machine tool Mx, and the like.

The information regarding a machine tool Mx received by the communication I/F 23 from the machine tool Mx is, for example, information managed by the machine tool Mx, and is, for example, information provided from the machine tool Mx to the hand-held terminal 2 to be displayed on the hand-held terminal 2 (i.e., display information).

When information specifying the machine tool Mx to be operated is input from the user, the operation unit 21 causes information representing the specified machine tool Mx (e.g., the tool name thereof) to be displayed on the display unit 22. In addition, when information specifying operation details is input from the user, the operation unit 21 causes information representing the specified operation details to be displayed on the display unit 22. The information representing the operation details specified by the user is, for example, a request for obtaining display information collected by the machine tool Mx, and/or the like.

Before an operation directed to the machine tool Mx is performed, the hand-held terminal 2 stores, in a storage unit (not illustrated) or the like, correspondence information that associates the tool names of the machine tools Mx with the IDs that identify the machine tools Mx. For example, the hand-held terminal 2 obtains, from the representative machine tool M1, information that associates the IDs and the tool names of the machine tools Mx operable from the hand-held terminal 2 (i.e., correspondence information) during first communication with the representative machine tool M1. The correspondence information of the embodiment associates the IDs of the respective machine tools M1, M2, and M3 with the tool names of the respective machine tools M1, M2, and M3. The ID of the representative machine tool M1 is first identification information, and the IDs of the remaining machine tools M2 and M3 are each second identification information.

The display unit 22 displays information (i.e., tool names) of the operable machine tools Mx included in the correspondence information obtained from the representative machine tool M1. This enables the user to select a machine tool Mx that the user wants to operate.

When the tool name and/or the like of the machine tool Mx identifying the machine tool Mx to be operated is input from the user, the hand-held terminal 2 reads, from the correspondence information, the ID associated with the tool name of the machine tool Mx specified by the user.

In addition, the hand-held terminal 2 receives, from the user, operation information, which is operation details directed to the machine tool Mx. The hand-held terminal 2 associates the tool name with the operation information input by the user.

The communication I/F 23 included in the hand-held terminal 2 is connected to the communication I/F 33 included in the representative machine tool M1 via a connection line L1. The communication I/F 23 sends the ID identifying the machine tool Mx specified by the user and the operation information representing an operation instruction directed to the machine tool Mx specified by the user, to the communication I/F 33 of the representative machine tool M1 via the connection line L1. That is, the communication I/F 23 adds the ID corresponding to the machine tool Mx selected by the user to the operation information, and sends the resulting operation information to the communication I/F 33. The operation information specified by the user represents detail of the operation directed to the machine tool Mx. The operation information directed to the representative machine tool M1 is first operation information, and the operation information directed to one of the remaining machine tools M2 and M3 (hereinafter, the remaining machine tool M2 or M3) is second operation information. Note that the connection line L1 may be provided by wire or wirelessly.

Note that the communication I/F 23 may send information including no ID to the communication I/F 33. In this case, the representative machine tool M1 determines that the representative machine tool M1 (that machine tool itself) connected to the hand-held terminal 2 is the machine tool to be operated.

In addition, the communication I/F 23 receives display information collected by the machine tool Mx, from the communication I/F 33 of the representative machine tool M1. The display information received by the communication I/F 23 from the communication I/F 33 is displayed on the display unit 22.

The communication I/F 33 of the representative machine tool M1 receives, from the communication I/F 23 of the hand-held terminal 2, the ID of the machine tool Mx and the operation information directed to this machine tool Mx. The communication I/F 33 sends the ID and the operation information received, to the HT communication control unit 31A.

The ID storage unit 34 of the representative machine tool M1 is a non-volatile memory. The ID storage unit 34 stores the ID table, which associates the IDs of the remaining machine tools M2 and M3 with the communication addresses of the remaining machine tools M2 and M3.

This ID table is pre-registered in the ID storage unit 34 by the user. The ID table of the embodiment stores information that associates the ID of the remaining machine tool M2 with the communication address of the remaining machine tool M2, and information that associates the ID of the remaining machine tool M3 with the communication address of the remaining machine tool M3.

The storage unit 32A of the representative machine tool M1 stores display information collected by the representative machine tool M1 and operation information received by the representative machine tool M1 from the hand-held terminal 2. The display information stored by the storage unit 32A of the representative machine tool M1 is information corresponding to the operation information received by the representative machine tool M1 from the hand-held terminal 2. In addition, the storage unit 32A preliminarily stores ID information (not illustrated) representing the ID of the representative machine tool M1.

The HT communication control unit 31A determines whether the ID received by the communication I/F 33 matches the ID of the representative machine tool M1, which is that apparatus itself, on the basis of the ID information stored in the storage unit 32A. When the HT communication control unit 31A determines that the ID received by the communication I/F 33 matches the ID of the representative machine tool M1, the representative machine tool M1 performs processing corresponding to the operation information received by the communication I/F 33. For example, when the operation information received by the representative machine tool M1 from the hand-held terminal 2 is information for performing processing of collecting the operational state of the representative machine tool M1, the representative machine tool M1 collects information on the operational state of the representative machine tool M1 (first operational state information) as display information, and stores the display information in the storage unit 32A.

When the ID received by the communication I/F 33 matches the ID of the representative machine tool M1, the HT communication control unit 31A sends the display information stored in the storage unit 32A to the communication I/F 33. Thus, the display information stored in the storage unit 32A is sent from the communication I/F 33 to the communication I/F 23.

When the ID received by the communication I/F 33 does not match the ID of the representative machine tool M1, that is, when the ID received by the communication I/F 33 matches the ID of one of the remaining machine tools M2 and M3, the HT communication control unit 31A relays the ID and the operation information to the corresponding one of the remaining machine tools.

Specifically, the HT communication control unit 31A reads the communication address corresponding to the ID received by the communication I/F 33 from the ID table stored in the ID storage unit 34. The HT communication control unit 31A sends the ID and the operation information received by the communication I/F 33 to the communication address that has been read. The HT communication control unit 31A sends the ID and the operation information via the hub 3.

As described above, the representative machine tool M1 communicates with the hand-held terminal 2 using the HT communication control unit 31A. In addition, the representative machine tool M1 relays information between the hand-held terminal 2 and the remaining machine tool M2 or M3 using the ID table. For example, when the ID received by the communication I/F 33 is the ID of the machine tool M2, the representative machine tool M1 sends the ID and the operation information received by the communication I/F 33 to the machine tool M2.

The HT communication control unit 31A controls communication with the hand-held terminal 2 directly connected to the representative machine tool M1 as described above. In addition, when the ID received from the hand-held terminal 2 is other than the ID of the representative machine tool M1, the HT communication control unit 31A converts the communication data (i.e., the operation information and the ID) sent from the hand-held terminal 2 into information for network communication, and sends that information to the remaining machine tool M2 or M3.

Moreover, when the HT communication control unit 31A receives display information directed to the hand-held terminal 2 from the remaining machine tool M2 or M3 via network communication, the HT communication control unit 31A converts the display information received, into information for communication with the hand-held terminal 2, and sends that information to the hand-held terminal 2. That is, the HT communication control unit 31A controls communication between the hand-held terminal 2 and the remaining machine tools M2 and M3, which are connected to the representative machine tool M1 via a network.

Due to similarity of configurations of the remaining machine tools M2 and M3, a configuration of the machine tool M2 will herein be described. The storage unit 32B of the machine tool M2 stores display information collected by the machine tool M2 and operation information received by the machine tool M2 from the hand-held terminal 2 via the representative machine tool M1. The display information stored by the storage unit 32B of the machine tool M2 is information corresponding to the operation information received by the machine tool M2 from the hand-held terminal 2 via the representative machine tool M1. In addition, the storage unit 32B preliminarily stores ID information (not illustrated) representing the ID of the machine tool M2.

The HT communication control unit 31B of the machine tool M2 determines whether the ID received from the hub 3 matches the ID of the machine tool M2, which is that apparatus itself, on the basis of the ID information stored in the storage unit 32B. When the HT communication control unit 31B determines that the ID received by the HT communication control unit 31B matches the ID of the machine tool M2, the machine tool M2 performs processing corresponding to the operation information received. For example, when the operation information received by the machine tool M2 is information for collecting the operational state of the machine tool M2, the machine tool M2 collects information on the operational state of the machine tool M2 as display information.

When the ID received by the representative machine tool M1 from the hand-held terminal 2 is the ID of the machine tool M2, the machine tool M2 is the second machine tool, and the information on the operational state of the machine tool M2 is the second operational state information. Alternatively, when the ID received by the representative machine tool M1 from the hand-held terminal 2 is the ID of the machine tool M3, the machine tool M3 is the second machine tool, and the information on the operational state of the machine tool M3 is the second operational state information. Still alternatively, when the representative machine tool M1 receives, from the hand-held terminal 2, IDs that are the IDs of the machine tools M2 and M3, the machine tools M2 and M3 are each the second machine tool, and the information on each of the operational states of the machine tools M2 and M3 is the second operational state information.

When the received ID matches the ID of the machine tool M2, the HT communication control unit 31B sends the display information stored in the storage unit 32A to the HT communication control unit 31A of the representative machine tool M1 via the hub 3. Thus, the display information stored in the storage unit 32B is sent to the hand-held terminal 2 via the representative machine tool M1. When the received ID does not match the ID of the machine tool M2, the HT communication control unit 31B sends information indicating an error to the representative machine tool M1.

A processing procedure of processing performed by the machining system 1 will next be described. Processing of the machining system 1 will first be described that is performed when the hand-held terminal 2 sends operation information to one of the machine tools M1 to M3 in the machining system 1.

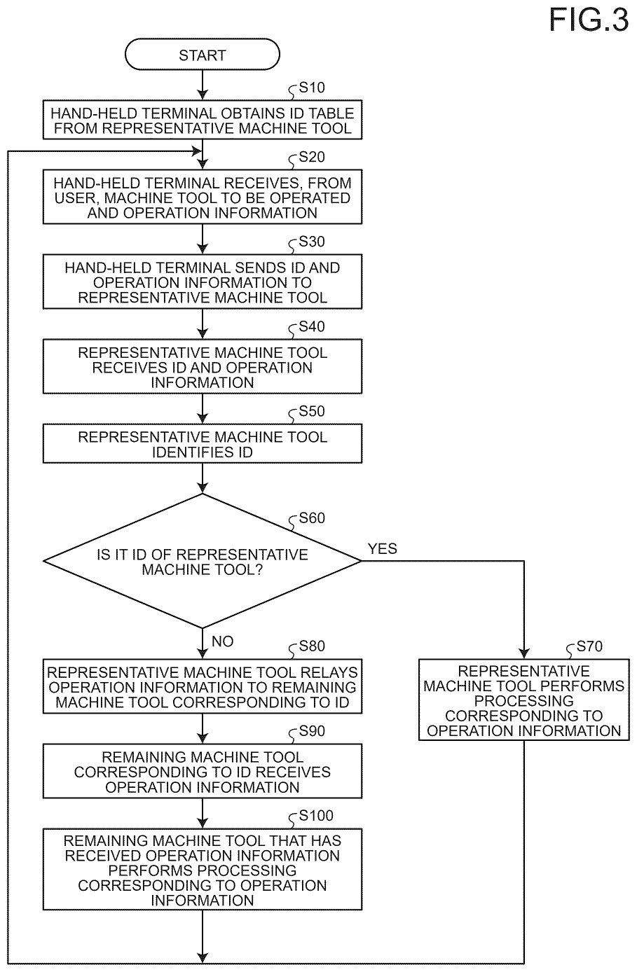

FIG. 3 is a flowchart illustrating a processing procedure followed by the machining system when the hand-held terminal sends operation information to a machine tool in the machining system according to the embodiment. In the machining system 1, the hand-held terminal 2 obtains the ID table from the representative machine tool M1 (step S10).

The operation unit 21 of the hand-held terminal 2 receives, from a user, information of the machine tool Mx to be operated and operation information (step S20). The operation unit 21 receives the tool name or the like of the machine tool Mx as the information of the machine tool Mx to be operated.

The user selects the machine tool Mx to be operated from, for example, the tool names of the multiple machine tools Mx displayed on the display unit 22 to thereby specify the machine tool Mx to be operated. The operation unit 21 receives the information of the machine tool Mx specified, as the information of the machine tool Mx to be operated.

The user also selects desired operation information from, for example, multiple items of operation information displayed on the display unit 22 to thereby specify the desired operation information. The operation unit 21 receives the operation information specified.

The hand-held terminal 2 reads the ID associated with the machine tool Mx specified by the user, from the correspondence information. The communication I/F 23 of the hand-held terminal 2 sends the ID and the operation information to the representative machine tool M1 (step S30).

The communication I/F 33 of the representative machine tool M1 receives the ID and the operation information (step S40). The HT communication control unit 31A of the representative machine tool M1 reads information of the ID attached to the information received from the hand-held terminal 2, and identifies the ID (step S50). That is, the HT communication control unit 31A determines of which machine tool Mx the ID is the ID. The HT communication control unit 31A determines whether the ID is the ID of the representative machine tool M1 (step S60).

When the ID is the ID of the representative machine tool M1 (Yes at step S60), the HT communication control unit 31A stores the operation information in the storage unit 32A, and the representative machine tool M1 performs processing corresponding to the operation information (step S70).

Note that also when the operation information sent from the hand-held terminal 2 includes no ID, the HT communication control unit 31A stores the operation information in the storage unit 32A. The representative machine tool M1 then performs processing corresponding to the operation information. In this manner, when the received ID is the ID of the representative machine tool M1 or when the received information includes no ID, the representative machine tool M1 determines that the operation information received is operation information directed to the representative machine tool M1, and performs processing corresponding to the operation information.

For example, when the operation information is information requesting collection of display information, the representative machine tool M1 collects display information corresponding to the operation information. The display information collected is stored in the storage unit 32A. When the operation information is information requesting collection of display information, the HT communication control unit 31A sends the display information to the communication I/F 33. The communication I/F 33 sends the display information collected by the representative machine tool M1 to the hand-held terminal 2.

When the ID is not the ID of the representative machine tool M1 (No at step S60), the HT communication control unit 31A relays the operation information to the remaining machine tool corresponding to the ID (step S80). Specifically, the HT communication control unit 31A reads the communication address corresponding to the ID from the ID table stored in the ID storage unit 34. The following description describes a case where the ID received by the representative machine tool M1 is the ID of the remaining machine tool M2, and the communication address read by the HT communication control unit 31A is the communication address of the remaining machine tool M2. The HT communication control unit 31A sends the operation information to the communication address that has been read. Note that the HT communication control unit 31A may also send the ID as well as the operation information to the communication address that has been read.

The remaining machine tool M2 corresponding to the communication address receives the operation information from the representative machine tool M1. That is, the remaining machine tool M2 corresponding to the ID received by the representative machine tool M1 receives the operation information (step S90).

After receiving the operation information, the remaining machine tool M2 stores the operation information in the storage unit 32B, and performs processing corresponding to the operation information (step S100).

After the operation at step S70 or after the operation at step S100, the machining system 1 returns the process to the operation at step S20, and performs the operations at and after step S20. Thus, the machining system 1 can operate the multiple machine tools Mx using the single hand-held terminal 2 without establishing another connection between a machine tool Mx and the hand-held terminal 2. This eliminates the need in the machining system 1 for carrying around the hand-held terminal 2 to establish another connection with a machine tool Mx, and can thus save the work of establishing another connection.

Note that the operation information may include multiple IDs. In this case, the machining system 1 performs the operations of steps S50 to S100 for each of the IDs included in the operation information.

In addition, the operation information may be information specifying performing of multiple operations. In this case, the machining system 1 performs the multiple operations provided in the operation information. These multiple operations may be operations directed to a single one of the machine tools Mx or directed to multiple ones of the machine tools Mx. When the operation information describes operations directed to multiple ones of the machine tools Mx, the hand-held terminal 2 sends, to the representative machine tool M1, multiple IDs corresponding to the machine tools Mx to be operated. When the operation information includes first operation information, which is operation information directed to the representative machine tool M1, and second operation information, which is operation information directed to the remaining machine tool M2 or M3, the operation information including the first operation information and the second operation information is third operation information.

The operation information may include, for example, information specifying an emergency stop of a machine tool Mx. When the operation information sent by the hand-held terminal 2 includes information triggering an emergency stop of a machine tool Mx, that machine tool Mx triggers an emergency stop of that machine tool Mx. For example, when the operation information received from the hand-held terminal 2 includes information triggering an emergency stop of the machine tool M1, the machine tool M1 triggers an emergency stop of the machine tool M1. In addition, when the operation information received from the machine tool M1 includes information triggering an emergency stop of the machine tool M2, the machine tool M2 triggers an emergency stop of the machine tool M2. Moreover, the operation information received from the hand-held terminal 2 includes information triggering an emergency stop of the machine tool M2, the machine tool M1 may trigger an emergency stop of the machine tool M2. Furthermore, when the operation information received from the hand-held terminal 2 includes information triggering an emergency stop of the machine tool M2, the machine tool M1 may trigger an emergency stop of the machine tool M1. Alternatively, when the operation information is information specifying emergency stops of multiple ones of the machine tools Mx, an emergency stop is triggered for each of the multiple ones of the machine tools Mx. For example, when the operation information sent by the hand-held terminal 2 includes information triggering emergency stops of the machine tools M1 and M2, the machine tools M1 and M2 respectively trigger emergency stops of the machine tools M1 and M2.

The operation information may be information causing multiple ones of the machine tools Mx to simultaneously perform operations. In this case, such operations may be a same operation or different operations among these machine tools Mx. When the operation information is information causing multiple ones of the machine tools Mx to simultaneously perform operations, the representative machine tool M1 causes these machine tools Mx to perform the multiple operations simultaneously.

In addition, the operation information may also be information specifying sequential operation of multiple ones of the machine tools Mx. Also in this case, the operation information includes multiple IDs that are IDs of the machine tools Mx to be operated sequentially. In this case, the operation information includes information of the order of performing the operations, and the representative machine tool M1 causes these machine tools Mx to operate sequentially on the basis of the information of the order. This facilitates operation of multiple ones of the machine tools using a single operational terminal.

When, for example, receiving an execution completion notification indicating that a first operation has been performed and completed, the representative machine tool M1 causes a second operation to be performed. In this case, the HT communication control unit 31A of the representative machine tool M1 causes a first machine tool Mx corresponding to the first operation to perform the first operation, and receives the execution completion notification from the first machine tool Mx. Then, the HT communication control unit 31A causes a second machine tool Mx corresponding to the second operation to perform the second operation, and receives an execution completion notification from the second machine tool Mx.

In this manner, the HT communication control unit 31A repeats processing of causing an N-th machine tool Mx (where N is a natural number) to perform an N-th operation, and after completion of the operation, causing an (N+1)-th machine tool Mx to perform an (N+1)-th operation. For example, when the operation information is information specifying sequential emergency stops of multiple ones of the machine tools Mx, the emergency stops are sequentially triggered for the multiple ones of the machine tools Mx. Note that the N-th machine tool Mx and the (N+1)-th machine tool Mx may be the representative machine tool M1.

Note that when the HT communication control unit 31A receives operation information of an emergency stop directed to one of the machine tools Mx, the HT communication control unit 31A may send an instruction to trigger an emergency stop to all the machine tools Mx and trigger an emergency stop of the representative machine tool M1. For example, when the HT communication control unit 31A receives operation information of an emergency stop directed to the representative machine tool M1, the HT communication control unit 31A sends an instruction to trigger an emergency stop to all of the remaining machine tools M2 and M3, and triggers an emergency stop of the representative machine tool M1.

The hand-held terminal 2 may preliminarily store an operation information set that is information associating operation information for performing multiple operations with the IDs of the machine tools Mx that are to perform operations provided in this operation information. In this case, when the user specifies an operation information set, the hand-held terminal 2 sends the operation information set specified, to the representative machine tool M1. The operation information set includes multiple pieces of operation information, multiple IDs, and information of the order of the operations.

In addition, the hand-held terminal 2 may receive, from the user, information similar to the operation information set. That is, the hand-held terminal 2 may receive, from the user, an operation information set including operation information for performing multiple operations, the IDs of the machine tools Mx that are to perform the operations provided in this operation information, and information of the order of the operations.

Processing of the machining system 1 will next be described that is performed when the remaining machine tool M2 or M3 sends display information corresponding to operation information to the hand-held terminal 2 in the machining system 1. The following description describes processing performed when the remaining machine tool M2 sends display information corresponding to operation information to the hand-held terminal 2.

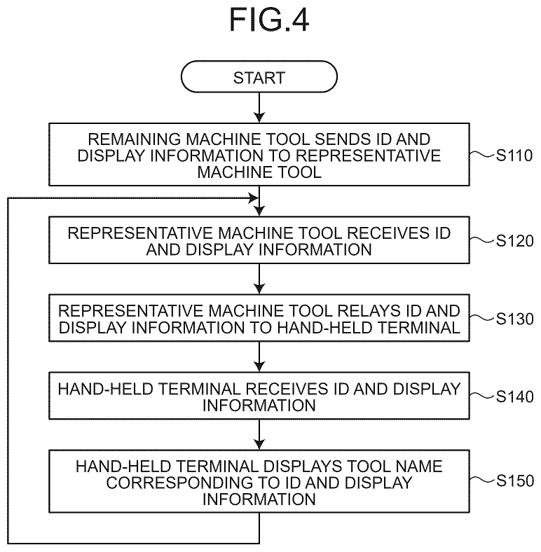

FIG. 4 is a flowchart illustrating a processing procedure followed by the machining system when the remaining machine tool sends display information corresponding to operation information to the hand-held terminal in the machining system according to the embodiment.

When receiving operation information that requests display information, the remaining machine tool M2 of the machining system 1 collects the display information. The HT communication control unit 31B of the remaining machine tool M2 then sends the ID of the remaining machine tool M2 and the display information collected, to the representative machine tool M1 (step S110).

The HT communication control unit 31A of the representative machine tool M1 receives the ID and the display information from the remaining machine tool M2 (step S120). The representative machine tool M1 relays the ID and the display information received by the HT communication control unit 31A to the hand-held terminal 2 (step S130).

The communication I/F 23 of the hand-held terminal 2 receives the ID and the display information from the representative machine tool M1 (step S140). The hand-held terminal 2 reads the tool name of the machine tool M2 corresponding to the ID received, from the correspondence information preliminarily stored, which associates the tool names with the IDs of the machine tools Mx. The display unit 22 of the hand-held terminal 2 displays the tool name corresponding to the ID and the display information (step S150). Note that the machine tools Mx may send information not to be displayed to the hand-held terminal 2 as the information corresponding to the operation information.

A hardware configuration of the hand-held terminal 2 and of the machine tools M1 to M3 will next be described. Note that the hand-held terminal 2 and the machine tools M1 to M3 have similar hardware configurations, and thus, a hardware configuration of the machine tool M1 will be described below.

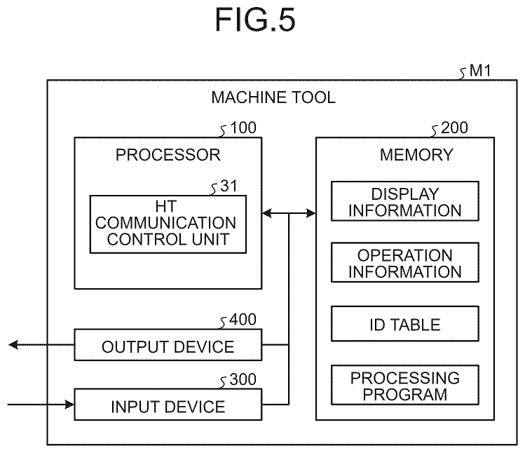

FIG. 5 is a diagram illustrating an exemplary hardware configuration for implementing the machine tools according to the embodiment. The machine tool M1 can be implemented by an input device 300, a processor 100, a memory 200, and an output device 400. Examples of the processor 100 include a central processing unit (CPU) (also known as processing unit, computing unit, microprocessor, microcomputer, and digital signal processor (DSP)) and a system large scale integration (LSI). Examples of the memory 200 include a random access memory (RAM) and a read-only memory (ROM).

The machine tool M1 is implemented in such a manner that the processor 100 reads and executes a computer-executable processing program stored in the memory 200 for performing operations of the machine tool M1. It can also be said that the processing program for performing operations of the machine tool M1 causes a computer to perform a procedure or method to be performed by the machine tool M1.

The processing program to be executed by the machine tool M1 has a modular structure including a module corresponding to the HT communication control unit 31. Such modules are loaded to a main memory, and are generated in the main memory. The processing program to be executed by the machine tool M1 includes a communication control program for controlling communication with the hand-held terminal 2, an operation-performing program for performing processing corresponding to operation information, and the like. The machine tool M1 is caused by the processing program to perform processing of receiving, from the hand-held terminal 2, operation information for operating the machine tool M1 or operation information for operating one or both of the machine tools M2 and M3. In addition, when receiving the operation information for operating the machine tool M1, the machine tool M1 is caused by the processing program to perform processing corresponding to this operation information; and when receiving the operation information for operating one or both of the machine tools M2 and M3, the machine tool M1 is caused by the processing program to perform processing of relaying this operation information to the machine tool(s) corresponding to the ID(s). The machine tool M1 is further caused by the processing program to perform processing of receiving display information from one or both of the machine tools M2 and M3 and processing of transferring the display information received, to the hand-held terminal 2.

The input device 300 receives an ID and operation information sent from the hand-held terminal 2, IDs and display information sent from the remaining machine tools M2 and M3, and the like, and sends the information received, to the processor 100. The memory 200 stores the display information, the operation information, the ID table, the processing program, and the like.

The processing program is read from the memory 200 by the processor 100. The memory 200 is used also as a temporary memory when the processor 100 performs various processing tasks. The output device 400 outputs an ID and display information to be sent to the hand-held terminal 2, IDs and operation information to be sent to the remaining machine tools M2 and M3, and the like.

The processing program may be provided in a form of a computer program product stored in a computer-readable storage medium, as an installable or executable file. The processing program may also be provided to the machine tool M1 via a network such as the Internet. Note that the functionality of the machine tool M1 may be implemented partially in a dedicated hardware element such as a dedicated circuit and partially in software or firmware.

As described above, the machining system 1 of the embodiment includes the representative machine tool M1 and the remaining machine tools M2 and M3 each connected to a network, and the hand-held terminal 2 connected to the representative machine tool M1 via the connection line L1 to manually operate the machine tools Mx. Then, when the representative machine tool M1 receives operation information directed to the representative machine tool M1 from the hand-held terminal 2, the representative machine tool M1 performs processing corresponding to the operation information. In addition, when the representative machine tool M1 receives operation information directed to the remaining machine tool M2 or M3, the representative machine tool M1 relays the operation information to the remaining machine tool M2 or M3 via the network, and when the remaining machine tool M2 or M3 receives the operation information, the remaining machine tool M2 or M3 performs processing corresponding to the operation information. This enables the machining system 1 to operate the multiple machine tools Mx using the single hand-held terminal 2 without establishing another connection between a machine tool Mx and the hand-held terminal 2.

The configurations described in the foregoing embodiment are merely examples. These configurations may be combined with another known technology, and configurations of different embodiments may be combined together. Moreover, part of such configurations may be omitted and/or modified without departing from the spirit.

### REFERENCE SIGNS LIST

1 machining system; 2 hand-held terminal; 3 hub; 21 operation unit; 22 display unit; 23, 33 Communication I/F; 31A-31C HT communication control unit; 32A-32C storage unit; 34 ID storage unit; 100 processor; 200 memory; 300 input device; 400 output device; L1 connection line; M1-M3, Mx machine tool.

1. A machining system comprising:
a first machine tool connected to a network;
a second machine tool connected to the network; and
manipulator for operating the first machine tool and the second machine tool, the manipulator being connected to the first machine tool via a connection line, wherein
the manipulator sends, to the first machine tool, first operation information for operating the first machine tool or second operation information for operating the second machine tool,
the first machine tool performs processing corresponding to the first operation information when the first machine tool receives the first operation information from the manipulator, and relays the second operation information to the second machine tool via the network when the first machine tool receives the second operation information from the manipulator,
the second machine tool performs processing corresponding to the second operation information when the second machine tool receives the second operation information, and
the second operation information comprises information of processing of causing a plurality of operations to be performed, and the first machine tool causes the second machine tool to simultaneously perform the plurality of operations.

2. The machining system according to claim 1, wherein
when the manipulator sends the first operation information to the first machine tool, the manipulator adds first identification information for identifying the first machine tool to the first operation information before sending the first operation information to the first machine tool, and when the manipulator sends the second operation information to the second machine tool, the manipulator adds second identification information for identifying the second machine tool to the second operation information before sending the second operation information to the first machine tool, and
when the first machine tool receives the first identification information, the first machine tool determines that the first machine tool has received the first operation information from the manipulator and performs processing corresponding to the first operation information, and when the first machine tool receives the second identification information, the first machine tool relays the second operation information to the second machine tool on a basis of the second identification information.

3.-4. (canceled)

5. The machining system according to claim 1, wherein
the manipulator stores an operation information set, and when a user selects the operation information set, the manipulator sends the operation information set to the first machine tool, the operation information set being operation information causing the plurality of operations to be performed, and
the first machine tool causes the plurality of operations specified in the operation information set to be performed.

6. The machining system according to claim 1, wherein
the manipulator sends third operation information to the first machine tool, the third operation information comprising the first operation information and the second operation information.

7. (canceled)

8. The machining system according to claim 1, wherein
the first machine tool triggers an emergency stop of the first machine tool when the first operation information received from the manipulator comprises information triggering the emergency stop of the first machine tool.

9. The machining system according to claim 8, wherein
the first machine tool triggers an emergency stop of the second machine tool when the first operation information received from the manipulator comprises information triggering the emergency stop of the second machine tool.

10. The machining system according to claim 1, wherein
the second machine tool triggers the emergency stop of the second machine tool when the second operation information received from the first machine tool comprises the information triggering the emergency stop of the second machine tool.

11. The machining system according to claim 10, wherein
the first machine tool triggers the emergency stop of the first machine tool when the second operation information received from the manipulator comprises the information triggering the emergency stop of the second machine tool.

12. The machining system according to claim 1, wherein
when the first operation information is information for collecting an operational state of the first machine tool,
the first machine tool collects first operational state information and sends the first operational state information to the manipulator when the first machine tool receives the first operation information from the manipulator, the first operational state information being information on the operational state of the first machine tool, and
the manipulator displays the first operational state information.

13. The machining system according to claim 1, wherein
when the second operation information is information for collecting an operational state of the second machine tool,
the second machine tool collects second operational state information and sends the second operational state information to the first machine tool when the second machine tool receives the second operation information from the first machine tool, the second operational state information being information on the operational state of the second machine tool,
the first machine tool sends the second operational state information to the manipulator, and
the manipulator displays the second operational state information.

14. The machining system according to claim 1, wherein
the first machine tool and the second machine tool are connected to each other via a hub in the network.

15. The machining system according to claim 1, wherein
the first machine tool and the second machine tool are directly connected to each other in the network.

16. A machining method comprising:
sending, by a manipulator of a machining system, first operation information for operating a first machine tool connected to a network or second operation information for operating a second machine tool connected to the network, to the first machine tool, the machining system comprising the first machine tool, the second machine tool, and the manipulator, the manipulator being for operating the first machine tool and the second machine tool and being connected to the first machine tool via a connection line;
performing, by the first machine tool, processing corresponding to the first operation information when the first machine tool receives the first operation information from the manipulator, and relaying, by the first machine tool, the second operation information to the second machine tool via the network when the first machine tool receives the second operation information from the manipulator; and
performing, by the second machine tool, processing corresponding to the second operation information when the second machine tool receives the second operation information,
wherein the second operation information comprises information of processing of causing a plurality of operations to be performed, and the first machine tool causes the second machine tool to simultaneously perform the plurality of operations.

17. (canceled)
